(19) United States
(12) Patent Application Publication
(10) Pub. No.: US 2026/0253120 A1
(43) Pub. Date: Aug. 27, 2026

(54) INFORMATION PROCESSING APPARATUS, INFORMATION PRESENTATION METHOD, AND STORAGE MEDIUM

(71) Applicant: NEC Corporation, Minato-ku, Tokyo (JP)

(72) Inventors: Masafumi OYAMADA, Tokyo (JP); Takuma NOZAWA, Tokyo (JP); Seiya ODA, Tokyo (JP)

(73) Assignee: NEC Corporation, Minato-ku, Tokyo (JP)

(21) Appl. No.: 18/870,774

(22) PCT Filed: Jun. 9, 2022
(86) PCT No.: PCT/JP2022/023325

§ 371 Date: Dec. 2, 2024

(51) Int. Cl. G06Q 30/0601; G06F 16/3329

(52) U.S. Cl. CPC G06Q 30/0631; G06F 16/33295

(57) ABSTRACT

To enable the presentation of useful information for recommending a recommendation target, an information processing apparatus (1) includes: a generation unit (11) that generates a question or a hypothesis appropriate to a recommendation target; and a presentation unit (12) that presents an answer to the question generated by the generation unit (11) or a result of verification of the hypothesis generated by the generation unit (11).

### TECHNICAL FIELD The present invention relates to a technique for recommending a product and a service.

### BACKGROUND ART

A technique for recommending a product and a service has been conventionally known. For example, Patent Literature 1 below discloses a product recommendation apparatus that generates purchase reason tendency-specific customer groups on the basis of purchase history information pertaining to a product and a product factor indicating a reason for purchase of the product and determines a recommendation product to be recommended to a customer on the basis of which of the purchase reason tendency-specific customer groups the customer belongs to.

### CITATION LIST

### Patent Literature

### [Patent Literature 1]

Japanese Patent Application Publication Tokukai No. 2015-201090

### SUMMARY OF INVENTION

### Technical Problem

The product recommendation apparatus disclosed in Patent Literature 1 is only capable of determining a recommendation product and is not capable of presenting useful information for recommending the determined recommendation product. In this point, there is room for improvement. An example aspect of the present invention has been made in view of the above viewpoint, and an example object thereof is to provide an information processing apparatus and the like that make it possible to present useful information for recommending a recommendation target.

### Solution to Problem

An information processing apparatus in accordance with an example aspect of the present invention includes: a generation means for generating a question or a hypothesis appropriate to a recommendation target which has been determined to be a target to be recommended to a target person; and a presentation means for presenting an answer to the question generated by the generation means or a result of verification of the hypothesis generated by the generation means.

An information presentation method in accordance with an example aspect of the present invention includes: at least one processor generating a question or a hypothesis appropriate to a recommendation target which has been determined to be a target to be recommended to a target person; and the at least one processor presenting an answer to the generated question or a result of verification of the generated hypothesis.

An information presentation program in accordance with an example aspect of the present invention causes a computer to function as: a generation means for generating a question or a hypothesis appropriate to a recommendation target which has been determined to be a target to be recommended to a target person; and a presentation means for presenting an answer to the question generated by the generation means or a result of verification of the hypothesis generated by the generation means.

### Advantageous Effects of Invention

An example aspect of the present invention makes it possible to present useful information for recommending a recommendation target.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an information presentation method in accordance with the first example embodiment of the present invention.

FIG. 3 is a view illustrating an outline of an information presentation method in accordance with a second example embodiment of the present invention.

FIG. 4 is a block diagram illustrating a configuration of an information processing apparatus in accordance with the second example embodiment of the present invention.

FIG. 5 is a view illustrating an example of generation of a prediction model and an example of generation of a recommendation reason.

FIG. 6 is a flowchart illustrating a flow of an information presentation method in accordance with the second example embodiment of the present invention.

FIG. 7 is a diagram illustrating an example of a computer that executes instructions of a program which is software realizing functions of apparatuses in accordance with the example embodiments of the present invention.

### DESCRIPTION OF EMBODIMENTS

### First Example Embodiment

A first example embodiment of the present invention will be described in detail with reference to the drawings. The present example embodiment is a basic form of an example embodiment described later.

### (Configuration of Information Processing Apparatus 1)

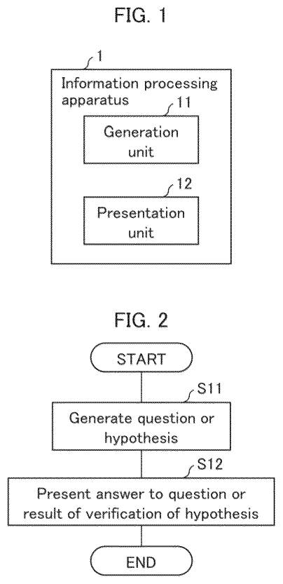

A configuration of an information processing apparatus 1 in accordance with the present example embodiment will be described with reference to FIG. 1. FIG. 1 is a block diagram illustrating the configuration of the information processing apparatus 1. As illustrated in FIG. 1, the information processing apparatus 1 includes a generation unit (generation means) 11 and a presentation unit (presentation means) 12.

The generation unit 11 generates a question or a hypothesis appropriate to a recommendation target which has been determined to be a target to be recommended to a target person. Note that the generation unit 11 may generate both the question and the hypothesis.

The presentation unit 12 presents an answer to the question generated by the generation unit 11 or a result of verification of the hypothesis generated by the generation unit 11. Note that, in a case where the generation unit 11 has generated both the question and the hypothesis, the presentation unit 12 may present both the answer to the question and the result of verification of the hypothesis. The generation of the answer to the question and the verification of the hypothesis may be carried out by the information processing apparatus 1 or may be carried out by another information processing apparatus.

As described above, the information processing apparatus 1 in accordance with the present example embodiment includes: the generation unit 11 that generates a question or a hypothesis appropriate to a recommendation target which has been determined to be a target to be recommended to a target person; and the presentation unit 12 that presents an answer to the question generated by the generation unit 11 or a result of verification of the hypothesis generated by the generation unit 11. Thus, the information processing apparatus 1 in accordance with the present example embodiment brings about the effect of making it possible to present useful information for recommending a recommendation target.

### (Information Presentation Program)

The functions of the information processing apparatus 1 described above can also be realized by a program. An information presentation program in accordance with the present example embodiment causes a computer to function as the generation unit 11 and the presentation unit 12. This information presentation program brings about the effect of making it possible to present useful information for recommending a recommendation target.

### (Flow of Information Presentation Method)

A flow of an information presentation method in accordance with the present example embodiment will be described with reference to FIG. 2. FIG. 2 is a flowchart illustrating the flow of the information presentation method. Note that steps of this information presentation method may be carried out by a processor included in the information processing apparatus 1 or by a processor included in another apparatus. Alternatively, the steps may be carried out by processors provided in respective different apparatuses.

In S11, at least one processor generates a question or a hypothesis appropriate to a recommendation target which has been determined to be a target to be recommended to a target person. Note that, in S11, both the question and the hypothesis may be generated.

In S12, at least one processor presents an answer to the question generated in S11 or a result of verification of the hypothesis generated in S11. Note that, in a case where both the question and the hypothesis have been generated in S11, both the answer to the question and the result of verification of the hypothesis may be presented.

As described above, the information presentation method in accordance with the present example embodiment includes: at least one processor generating a question or a hypothesis appropriate to a recommendation target which has been determined to be a target to be recommended to a target person; and the at least one processor presenting an answer to the generated question or a result of verification of the generated hypothesis. This information presentation method brings about the effect of making it possible to present useful information for recommending a recommendation target.

### Second Example Embodiment

### (Outline of Information Presentation Method)

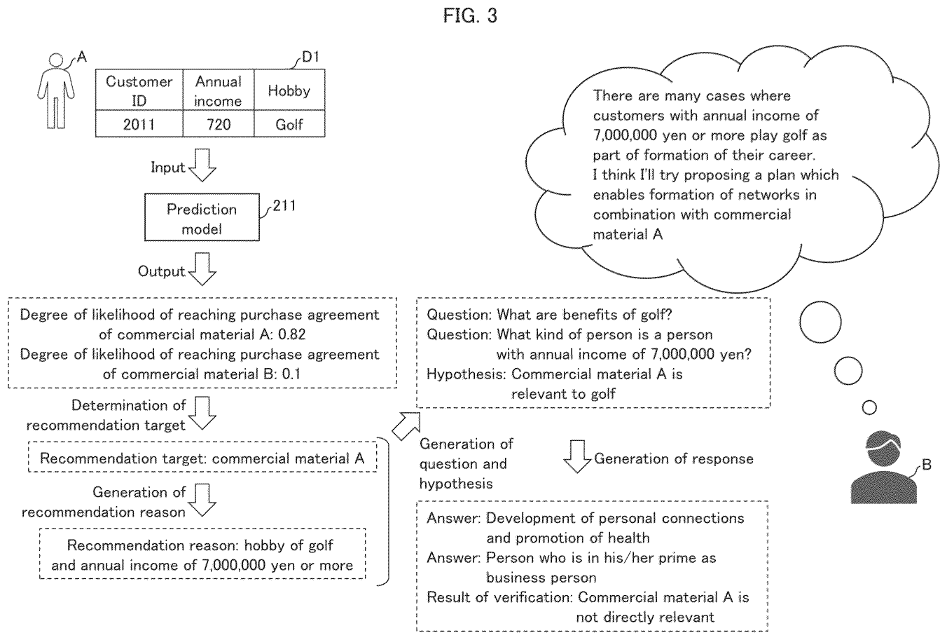

FIG. 3 is a view illustrating an outline of the information presentation method (hereinafter referred to as the present method) in accordance with the present example embodiment. FIG. 3 illustrates two persons, a person A and a person B. Among these persons, the person B is a recommender who recommends a recommendation target such as a product and a service, and the person A is a target person who receives the recommendation.

The person B may be, for example, a sales person. In this case, how to recommend what kind of commercial material to the person A has influence over the success or failure of a sale, that is, whether to reach a purchase agreement of a commercial material recommended by the person B. According to the present method, it is possible to present, to the person B, useful information for recommending a recommendation target and make a sales activity of the person B more effective.

In the present method, first, attribute data D1 indicating what kind of person the person B that is a target person who receives a recommendation is is input to a prediction model 211 to predict, for each of commercial materials which are candidates for recommendation, the degree of likelihood of reaching a purchase agreement of a commercial material as a result of recommending the commercial material to the person A. In the example of FIG. 3, predictions about a commercial material A and a commercial material B, which are candidates for recommendation, are made that the degree of likelihood of reaching a purchase agreement of the commercial material A is 0.82, and the degree of likelihood of reaching a purchase agreement of the commercial material B is 0.1. Note that the commercial materials A and B, which are recommendation targets, may each be an object, a service, or a combination of an object and a service. In addition, details of the prediction model 211 will be described later.

In this example, since the numerical range of the degree of likelihood is 0 to 1, it can be said that there is a high possibility that a purchase agreement of the commercial material A will be reached as a result of recommending the commercial material A, and there is a low possibility that a purchase agreement of the commercial material B will be reached as a result of recommending the commercial material B. Therefore, in this example, the recommendation target is determined to be the commercial material A. Note that whether or not the degree of likelihood of reaching a purchase agreement is high may be determined on the basis of a predetermined threshold value. That is, in the present method, the recommendation target may be determined to be the one such that the degree of likelihood determined with use of the prediction model 211 is equal to or greater than a threshold value.

Next, in the present method, a recommendation reason for recommendation of a determined recommendation target is generated. In the example of FIG. 3, the recommendation reason is a point that the person A plays golf as a hobby and has an annual income of 7,000,000 yen or more. The recommendation reason is information useful for recommending the commercial material A. However, only from the recommendation reason illustrated in FIG. 3, a relationship between the characteristics of the person A, which are the hobby of golf and the annual income of 7,000,000 yen or more, and the commercial material A is not clear for the person B. Thus, there is a possibility that the person B may not successfully appeal the commercial material A to the person A.

In view of this, in the present method, a question and a hypothesis appropriate t the recommendation target determined as described above are generated. In the example of FIG. 3, questions “What are benefits of golf?” and “What kind of person is a person with an annual income of 7,000,000 yen?” and a hypothesis that “Commercial material A is relevant to golf” are generated. Note that, in the present method, either the question or the hypothesis only may be generated. In addition, only one question may be generated, or a plurality of questions may be generated. The same applies to the hypothesis. Note that a method for generating the question and the hypothesis will be described later.

Then, in the present method, generated are responses to the question and the hypothesis generated as described above. In the example of FIG. 3, “Development of personal connections and promotion of health”, which is an answer to the question “What are benefits of golf?”, is generated, and “A person who is in his/her prime as a business person”, which is an answer to the question “What kind of person is a person with an annual income of 7,000,000 yen?”, is generated. In addition, with regard to the hypothesis that “Commercial material A is relevant to golf”, a result of verification that “Commercial material A is not directly relevant” is generated.

In the present method, the answers and the result of verification which have been generated as described above are presented to the person B. These pieces of information are useful information for the person B recommending the commercial material A to the person A. For example, in the example of FIG. 3, the person B who received the presentation of the answers and the result of verification has come to think that there are many cases where customers with an annual income of 7,000,000 yen or more play golf as part of formation of their career. Then, the person B obtains an idea of proposing a plan which enables the formation of networks in combination with the commercial material A. Thus, the answers and the result of verification which are presented by the present method are useful information that contributes to making a sales activity of the person B more effective.

As described above, the present method includes: generating a question or a hypothesis appropriate to a recommendation target (commercial material A in the example of FIG. 3) which is to be recommended to a target person (person A in the example of FIG. 3); and presenting an answer to the generated question or a verification of the generated hypothesis. Thus, the present method brings about the effect of making it possible to present useful information for recommending a recommendation target.

Note that a target to whom information is presented in the present method may be a target person who receives a recommendation. For example, in some online shopping sites, products to be recommended to viewers of the online shopping sites are automatically determined and presented. In such shopping sites, the present method may allow a question or a hypothesis appropriate to the product to be recommended to be generated and allow an answer to the question or a result of verification of the hypothesis to be presented together with the product to be recommended. This enables the viewer to recognize a reason and a background why that product is recommended or various pieces of information pertaining to that product itself so that the viewer is motivated to purchase the product.

### (Configuration of Information Processing Apparatus 2)

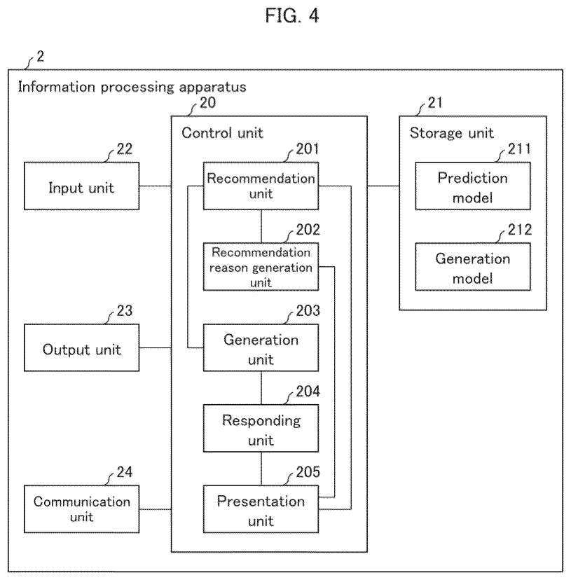

A configuration of an information processing apparatus 2 in accordance with the present example embodiment will be described with reference to FIG. 4. FIG. 4 is a block diagram illustrating the configuration of the information processing apparatus 2. As illustrated in FIG. 4, the information processing apparatus 2 includes: a control unit 20 that centrally controls each unit of the information processing apparatus 2; and a storage unit 21 that stores various data used by the information processing apparatus 2. Further, the information processing apparatus 2 includes: an input unit 22 that receives an input operation of a user with respect to the information processing apparatus 2; an output unit 23 that allows the information processing apparatus 2 to output data; and a communication unit 24 that allows the information processing apparatus 2 to communicate with other apparatus.

Further, the control unit 20 includes a recommendation unit (recommendation means) 201, a recommendation reason generation unit (recommendation reason generation means) 202, a generation unit (generation means) 203, a responding unit (responding means) 204, and a presentation unit (presentation means) 205. The storage unit 21 stores a prediction model 211 and a generation model 212.

The recommendation unit 201 determines a recommendation target to be recommended to a target person. The recommendation target may be an object, a service, or a combination of an object and a service, as described above. In addition, it is desirable that the recommendation target be the one appropriate to an attribute of the target person. For example, the recommendation unit 201 may determine a recommendation target appropriate to the attribute of the target person with use of the prediction model 211. Note that the prediction model 211 will be described in the later section “Recommendation target determination method and recommendation reason generation method”. The recommendation reason generation unit 202 generates a recommendation reason for recommendation of the recommendation target determined by the recommendation unit 201. To be more precise, the recommendation reason generation unit 202 generates information indicating the recommendation reason for recommendation of the recommendation target determined by the recommendation unit 201. Herein, the information indicating the recommendation reason is referred to simply as the recommendation reason. A method for generating the recommendation reason will be described in the later section “Recommendation target determination method and recommendation reason generation method”.

The generation unit 203 generates a question or a hypothesis appropriate to the recommendation target determined by the recommendation unit 201. To be more precise, the generation unit 203 generates a question sentence which is a sentence of a question expressed in a natural language or a hypothesis sentence which is a sentence of a hypothesis expressed in a natural language. Herein, the hypothesis sentence is referred to simply as hypothesis, and the question sentence is referred to simply as question. The generation model 212 can also be used for the generation of a question or a hypothesis. Note that a question generation unit that generates a question and a hypothesis generation unit that generates a hypothesis may be provided as separate blocks. Details of a method for generating a question and a hypothesis and the generation model 212 will be described in the later section “Question and hypothesis generation method”.

The responding unit 204 generates a response to the question or the hypothesis generated by the generation unit 203. Note that an answer generation unit that generates an answer to the question and a hypothesis verification unit that generates a result of verification of the hypothesis may be provided as separate blocks. Since both the question and the hypothesis which are generated by the generation unit 203 are sentences as described above, it is possible to generate responses to the question and the hypothesis with use of the technology of natural language processing. Details of a method for generating an answer to a question and a method for verifying a hypothesis will be described in the later section “Answer generation method and hypothesis verification method”.

The presentation unit 205 presents an answer to the question generated by the generation unit 203 or a result of verification of the hypothesis generated by the generation unit 203. A method for presentation only needs to be a method that allows details to be presented to be recognized by a target to which the details to be presented are to be presented. For example, in a case where the output unit 23 is a display apparatus, the presentation unit 205 may present an answer or a result of verification by outputting the answer or the result of verification to the output unit 23 so that the answer or the result of verification is displayed. Alternatively, for example, in a case where the output unit 23 is an audio output apparatus, the presentation unit 205 may present an answer or a result of verification by outputting the answer or the result of verification to the output unit 23 so that the answer or the result of verification is output as audio. Alternatively, the presentation unit 205 may output the answer or the result of verification to an apparatus outside the information processing apparatus 2.

As described above, the information processing apparatus 2 in accordance with the present example embodiment includes: the generation unit 203 that generates a question or a hypothesis appropriate to a recommendation target which has been determined to be a target to be recommended to a target person; and the presentation unit 205 that presents an answer to the question generated by the generation unit 203 or a result of verification of the hypothesis generated by the generation unit 203. Thus, the information processing apparatus 2 in accordance with the present example embodiment brings about the effect of making it possible to present useful information for recommending a recommendation target.

### (Recommendation Target Determination Method and Recommendation Reason Generation Method)

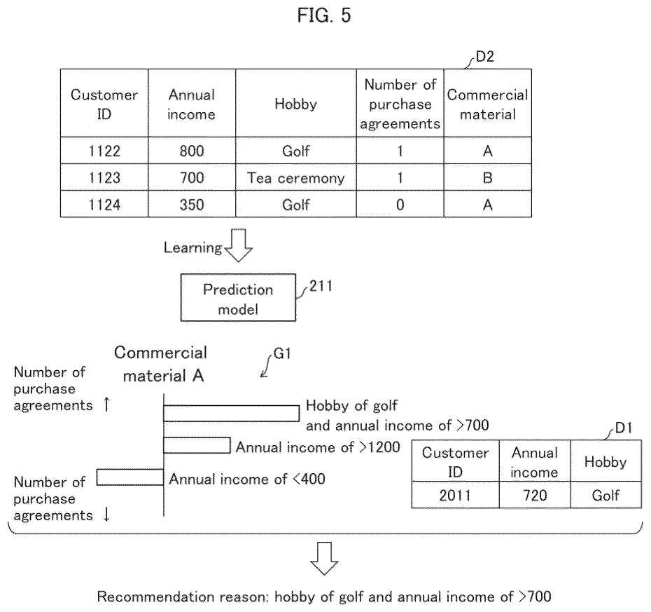

A recommendation target determination method carried out by the recommendation unit 201 and a recommendation reason generation method carried out by the recommendation reason generation unit 202 will be described on the basis of FIG. 5. FIG. 5 is a view illustrating an example of generation of the prediction model 211 and an example of generation of a recommendation reason.

In the example of FIG. 5, the prediction model 211 is generated by learning with use of training data D2. The training data D2 is data indicating, in correspondence with an identification (ID, identification information) of each of a plurality of customers, an annual income and a hobby of a customer, a commercial material a purchase of which has been proposed to a customer, and whether or not a purchase agreement of the commercial material has been reached.

The training data D2 indicates a relationship between an attribute of a person and a result of recommendation of a recommendation target to the person who has the attribute. Thus, training with use of the training data D2 enables generation of the prediction model 211 for predicting the degree of likelihood of reaching a purchase agreement of a specific commercial material in a case where purchase of the specific commercial material is recommended to a target person on the basis of the attribute of the target person.

The prediction model 211 is information that represents a relationship between an explanatory variable and an objective variable. The prediction model 211 is, for example, a component for estimating a result of an estimation target by calculating an objective variable based on an explanatory variable. The prediction model 211 is generated by executing a training algorithm by using, as input, an arbitrary parameter and training data for which a value of an objective variable has already been obtained. For example, the prediction model 211 may be represented by a function c that maps an input x to a correct answer y. The prediction model 211 may estimate a numerical value of the estimation target or may estimate a label of the estimation target. Further, the prediction model 211 may output a variable describing a probability distribution of the objective variable. Note that the prediction model 211 may be described as, for example, a “training model”, an “analysis model”, an “artificial intelligence (AI) model”, a “trained model”, an “inference model”, or a “prediction expression”. The explanatory variable is a variable used as an input in the prediction model. The explanatory variable may be described as, for example, a “feature amount” or a “feature”.

The prediction model 211 only needs to be capable of predicting the degree of likelihood of reaching a purchase agreement, and a training algorithm for generating the prediction model is not particularly limited. For example, the training algorithm for generating the prediction model 211 may be a random forest, a support vector machine, Naive Bayes, or a neural network.

Alternatively, the prediction model 211 may be a piecewise linear model. The piecewise linear model is constructed by setting segments to enable prediction by a linear model and generating a linear model for each segment. For example, assume that settings are made for a total of the following three segments: a segment 1 in which the attribute value of the “hobby” is “golf”, and the attribute value of the “annual income” is “700” or more; a segment 2 in which the attribute value of the “annual income” is “1200” or more; a segment 3 in which the attribute value of the “annual income” is “400” or less. In this case, for each of these segments, a linear model for predicting the degree of likelihood of reaching a purchase agreement of the commercial material A as a result of recommending the commercial material A is generated from the attribute values of a target person.

Note that, as a method for generating the segmented linear model, there is a method in which factorized asymptotic Bayesian inference (FAB inference) is used. A method for generating a piecewise linear model using the FAB inference is disclosed in, for example, U.S. Patent Application Publication No. US 2014/0222741 A1.

In a case where the recommendation unit 201 determines a recommendation target with use of the piecewise linear model, the recommendation unit 201 identifies a segment of a target person on the basis of the attribute of the target person and predicts the degree of likelihood of reaching a purchase agreement by a linear model corresponding to the identified segment. For example, in the case of a person of attribute data D1 (person whose customer ID is 2011) illustrated in FIG. 5, the “annual income” is “720”, and the “hobby” is “golf”. Thus, the recommendation unit 201 identifies the person of the attribute data D1 as falling into the above-described segment 1 and predicts the degree of likelihood of reaching a purchase agreement of the commercial material A as a result of recommending the commercial material A to that person on the basis of the attribute value indicated in the attribute data D1 (for example, the value of “annual income”) by the linear model corresponding to the segment 1.

As described above, the recommendation unit 201 can predict, for each of recommendation target candidates, the degree of likelihood of reaching a purchase agreement of each recommendation target candidate with use of the prediction model 211. Then, the recommendation unit 201 can determine a recommendation target on the basis of results of the prediction. For example, the recommendation unit 201 may determine a candidate having the highest degree of likelihood of reaching a purchase agreement to be a recommendation target or may determine a candidate having the degree of likelihood of reaching a purchase agreement equal to or greater than a predetermined threshold value to be a recommendation target.

Next, a method for generating a recommendation reason will be described. In a case where the prediction model 211 is a piecewise linear model, the recommendation reason generation unit 202 may determine a condition defined for a segment into which a target person falls among segments of the prediction model 211 to be a recommendation reason. For example, the person whose customer ID is 2011 shown in the attribute data D1 belongs to the segment 1 (segment corresponding to characteristics of having a hobby of golf and having an annual income of >700) among the segments 1 to 3 of the above-described piecewise linear model. Thus, the recommendation reason generation unit 202 may determine the point that the person whose customer ID is 2011 plays golf as a hobby and has an annual income of 7,000,000 yen or more to be a recommendation reason for recommending the commercial material A to the person whose customer ID is 2011.

A graph G1 illustrated in FIG. 5 indicates, for each of the segments 1 to 3 of the above-described piecewise linear model, the number of cases that reached purchase agreements with persons who belong to each segment. In the graph G1, a segment in which the number of cases that reached purchase agreements is large is ranked higher, and a segment in which the number of cases that did not reach purchase agreements is large is ranked lower. The person whose customer ID is 2011 shown in the attribute data D1 belongs to the segment 1 (segment corresponding to characteristics of having a hobby of golf and having an annual income of >700) in which the number of cases that reached purchase agreements is the largest in the graph G1. Thus, it can be said that the point that the person whose customer ID is 2011 plays golf as a hobby and has an annual income of 7,000,000 yen or more is an appropriate reason (also can be said to be an appropriate ground) for recommending the commercial material A to that person.

Note that the above-described recommendation target determination method and the above-described recommendation reason generation method are merely examples. For example, for the determination of a recommendation target, a prediction model generated by learning a relationship between an attribute of a person and a recommendation target to be recommended to the person who has the attribute may be used. In this case, the output of the prediction model is the recommendation target.

In addition, a format of input data to be input to the information processing apparatus 2 to determine a recommendation target is not particularly limited. For example, the attribute data D1 in a table format as illustrated in FIG. 5 can be used as the input data. In addition, data in other data format such as an image and a sound can be used as the input data. The input data may be subjected to format conversion as necessary prior to being used for the determination of a recommendation target.

In addition, a prediction algorithm is not particularly limited. For example, as in the case of an attribution model, prediction of the degree of likelihood of reaching a purchase agreement may be performed with use of a predefined rule or the like. In addition, it is also possible to determine a recommendation target without using a prediction model generated by machine learning. For example, in a case where purchase history information of a product or a service is available, customers may be classified under a plurality of groups in advance in accordance with a purchase tendency and a customer attribute with use of the purchase history information. In this case, the recommendation unit 201 may classify a target person into any group and determine a recommendation target according to the purchase tendency of the group (for example, a high purchase frequency in the group or a large total purchase amount in the group).

In addition, as the recommendation reason generation method, an arbitrary method appropriate to the recommendation target determination method may be employed as appropriate. For example, the recommendation reason generation unit 202 may determine an attribute having a relatively strong correlation with a purchase agreement of a commercial material among target person's attributes used for the determination of a recommendation target to be the recommendation reason. For example, assume that an attribute common to a large number of persons with whom purchase agreements of a specific commercial material were reached in past cases is a hobby of watching videos. In this case, if the attribute of a target person includes a hobby of watching videos, the recommendation reason generation unit 202 may determine the recommendation reason for recommendation of the commercial material to be the point that the hobby is watching videos or the point that purchase agreements of the commercial material with persons having a hobby of watching videos are reached at a high rate.

### (Question and Hypothesis Generation Method)

A question and hypothesis generation method carried out by the generation unit 203 will be described. Various approaches can be employed as the question and hypothesis generation method. For example, the generation unit 203 may generate a question and a hypothesis with use of the generation model 212 that has been generated by learning a relationship between a recommendation target and a question or a hypothesis appropriate to the recommendation target. This brings about, in addition to the effect brought about by the information processing apparatus 1 in accordance with the first example embodiment, the effect of making it possible to generate a reasonable question or hypothesis based on a learning result.

For example, it is possible to generate the generation model 212 that generates a question and a hypothesis from various kinds of information pertaining to a recommendation target by learning with use of training data in which the various kinds of information pertaining to the recommendation target is associated with a doubt that a sales person in charge has held about the information and a hypothesis that the sales person in charge has conceived from the information. Note that the generation model is not limited to a model that has learned with use of training data. The generation model may be a model generated by unsupervised learning, such as a generic adversarial network (GAN).

Examples of the various kinds of information pertaining to the recommendation target include an attribute of the recommendation target (for example, a product name, a product genre, a price or a price range, a target age, and the like), a recommendation reason, an attribute of a target person or a recommender (for example, age, gender, occupation, income, career, and affiliation), and the like. In addition, for example, the degree of likelihood (predicted by the prediction model 211) of reaching a purchase agreement of the recommendation target may be used as the information pertaining to the recommendation target.

In a case where the attribute of the target person is used as the information pertaining to the recommendation target, it is possible to generate a question or a hypothesis appropriate to the target person. For example, it is also possible to generate a question or a hypothesis appropriate to the gender and age group of the target person. This makes it possible to present an answer or a hypothesis verification result appropriate to the gender and age group of the target person.

Further, in a case where the attribute of the recommender is used as the information pertaining to the recommendation target, it is possible to generate a question or a hypothesis appropriate to the recommender. For example, it is also possible to generate a question or a hypothesis appropriate to the length of working experience of the recommender as a sales person and present an answer to the question or a hypothesis verification result. This enables the recommender who has received the presentation to provide, to a target person, an explanation suitable for the length of working experience of the recommender as a sales person.

Further, in a case where the degree of likelihood of reaching a purchase agreement of the recommendation target and the degree of likelihood of suitability of the recommendation target for the target person are used as the information pertaining to the recommendation target, it is possible to generate a question or a hypothesis appropriate to the degree of likelihood and present an answer to the question or a result of verification of the hypothesis. For example, in a case where the degree of likelihood is equal to or greater than a predetermined threshold value, the generation unit 203 may generate a question or a hypothesis that includes predetermined wording (for example, “recommended with confidence”, “especially recommended”, “most suitable for a target person”, and the like) which reflects a high degree of likelihood. Further, for example, the generation unit 203 may generate a question or a hypothesis with use of different generation models and different templates, depending on whether a case where the degree of likelihood is equal to or greater than a predetermined threshold value or a case where the degree of likelihood is less than the predetermined threshold value. The generation of a question or a hypothesis with use of a template will be described later.

Alternatively, the generation unit 203 may generate a question and a hypothesis without using the generation model 212. For example, the generation unit 203 can also generate a question and a hypothesis with use of rules created in advance and/or templates created in advance. For example, the generation unit 203 can extract the word “golf”, which is a value of the attribute “hobby”, from the recommendation reason in the example of FIG. 3 with use of a template “What are benefits of (a value of a predetermined attribute extracted from a recommendation reason)?” and generate the question sentence “What are benefits of golf?”. Similarly, the generation unit 203 can extract the word “7,000,000”, which is a value of the attribute “annual income”, from the recommendation reason in the example of FIG. 3 with use of a template “What kind of person is a person with (a predetermined attribute extracted from a recommendation reason) of (a value of the attribute)?” and generate the question sentence “What kind of person is a person with an annual income of 7,000,000 yen?” The same applies to a hypothesis. For example, the generation unit 203 can generate the hypothesis that “Commercial material A is relevant to golf” from the recommendation target and the recommendation reason in the example of FIG. 3 with use of a template “(recommendation target) is relevant to (a value of a predetermined attribute extracted from the recommendation reason)”.

Examples of the rule used for the generation of a question and a hypothesis include replacement of a word. For example, a rule that the word “golf” is replaced with “sports” of a wider concept or a rule that the value of the attribute “annual income” is replaced with “high-income group”, “medium-income group”, or the like according to a range within which the value falls may be specified. By employing such a rule, it becomes possible to generate more versatile questions and hypotheses. For example, instead of the above-described question sentence “What are benefits of golf?” or in addition to such a question sentence, it becomes possible to generate a more general question sentence “What are benefits of sports?”.

Another example of the rule used for the generation of a question and a hypothesis includes a rule that a template to be used is selected according to an attribute or the like used for the generation. For example, a rule that a template “What are benefits of (hobby)?” is used for the generation of a question about the attribute “hobby” and a rule that a template “What kind of person is a person with an annual income of (an attribute value of the annual income)?” for the generation of a question about the attribute “annual income” In generating a question or a hypothesis with use of a rule and a template, for example, information pertaining to a recommendation target, such as an attribute of the recommendation target (for example, a product name, a product genre, a price or a price range, a target age, and the like), a recommendation reason, an attribute of a target person or a recommender (for example, age, gender, occupation, income, and the like) may be used as a material for the question or the hypothesis.

As described above, the generation unit 203 may generate a question or a hypothesis on the basis of a recommendation reason generated by the recommendation reason generation unit 202. This brings about, in addition to the effect brought about by the information processing apparatus 1 in accordance with the first example embodiment, the effect of making it possible to present in-depth information based on a recommendation reason.

In addition, as described above, the recommendation unit 201 may determine a recommendation target appropriate to an attribute of a target person with use of the prediction model 211 that has been generated by learning a relationship between an attribute of a person and a result of recommendation of a recommendation target to the person who has the attribute or a relationship between an attribute of a person and a recommendation target to be recommended to the person who has the attribute. Then, in this case, the generation unit 203 may generate a question or a hypothesis appropriate to the degree of likelihood of a prediction result obtained by the prediction model 211. This brings about, in addition to the effect brought about by the information processing apparatus 1 in accordance with the first example embodiment, the effect of making it possible to present information factoring in the degree of likelihood of a prediction result.

In addition, as described above, the generation unit 203 may generate a question or a hypothesis on the basis of an attribute of a target person. This brings about, in addition to the effect brought about by the information processing apparatus 1 in accordance with the first example embodiment, the effect of making it possible to present information suitable for a target person.

In addition, as described above, the generation unit 203 may generate a question or a hypothesis on the basis of an of who recommendation target to a target person. This brings about, in addition to the effect brought about by the information processing apparatus 1 in accordance with the first example embodiment, the effect of making it possible to present information suitable for a recommender.

### (Answer Generation Method and Hypothesis Verification Method)

Details of a method for generating an answer to question and a hypothesis verification method, both of which are carried out by the responding unit 204, will be described. An answer to a question can be generated with use of, for example, a corpus outside the information processing apparatus 2. The corpus is a large-scale collection of structured natural language sentences. In this case, the responding unit 204 detects, from among a large number of question sentences included in the corpus, a question sentence which is identical or similar to a question sentence generated by the generation unit 203 and generates an answer sentence associated with the question sentence as an answer to the question generated by the generation unit 203. Alternatively, an answer can be similarly generated with use of a knowledge graph instead of the corpus. The knowledge graph is represented by a graph structure in which various kinds of knowledge are systematically connected.

On the other hand, verification of a hypothesis can be carried out with use of a premise sentence the content of which is known to be correct and a language understanding model. The language understanding model is a model that is constructed so as to, upon receiving a set of a hypothesis sentence and a premise sentence as input, output an entailment score, which is an index value indicating the degree of entailment of the hypothesis sentence by the premise sentence. Such a language understanding model can be constructed by learning whether or not a premise sentence entails a hypothesis sentence with use of a set of a premise sentence and a hypothesis sentence whose entailment relationship is known as training data.

For example, the responding unit 204 may perform, with use of various premise sentences, processing for inputting a hypothesis sentence generated by the generation unit 203 and each premise sentence into a language understanding model, and, in a case where there is a premise sentence having an entailment store equal to or greater than a threshold value, determine that a hypothesis of the hypothesis sentence is correct.

Note that a method for determining the degree of entailment is not limited to the method described above using the language understanding model that is constructed with use of training data. For example, the responding unit 204 may calculate the degree of similarity between a premise sentence and a hypothesis sentence that have been vectorized by a pre-trained language model, and regard the calculated degree of similarity as the index value indicating the degree of entailment.

Further, for the determination of the degree of entailment, an arbitrary determination method can be employed, provided that a relationship between a hypothesis sentence and a premise sentence can be defined. For example, an existing technique such as keyword matching and inverse document frequency (TF-IDF) may be used as a method for determining the degree of entailment.

### (Presentation of Answer and Result of Verification)

The presentation unit 205 may present an answer to a question generated by the generation unit 203 or a result of verification of a hypothesis generated by the generation unit 203 as it is. Alternatively, the presentation unit 205 may generate presentation data with use of the answer or the result of verification and present the generated presentation data. A method for generating the generation data is not particularly limited, and the presentation data may be generated with use of, for example, a predetermined rule or a predetermined template. For example, in a case where the above-described answer or the above-described result of verification is a word(s), the presentation unit 205 may use, as the presentation data, a sentence constructed by embedding the word(s) in a template. For example, the presentation unit 205 can construct a sentence “The benefits of golf are development of personal connections and promotion of health.” from the answer “Development of personal connections and promotion of health” in the example of FIG. 3 with use of a template “The benefits of (value of the attribute ”hobby“) are (word(s) included in an answer to a question).” and present the sentence.

Further, the presentation unit 205 may generate a sentence appropriate to an answer or a result of verification with use of, for example, a sentence generation model that has been generated by learning, as training data, an explanation, a phrase, and the like that were used by a sales person and proved effective. This enables even an immature sales person to perform an effective sales activity.

Note that it is desirable that the presentation unit 205 present not only an answer or a result of verification but also a corresponding question, a corresponding hypothesis, a corresponding recommendation target, and a corresponding recommendation reason. Further, the presentation unit 205 may also present various kinds of information pertaining to a recommendation target (for example, specifications of the recommendation target, an image indicating an appearance of the recommendation target, word-of-mouth reputation of the recommendation target, and the like), an attribute of the target person, and the like.

### (Reception of Question About Presented Answer or About Presented Result of Verification)

The responding unit 204 may receive input of a question about an answer presented by the presentation unit 205 or about a result of verification presented by the presentation unit 205. Then, the responding unit 204 may generate an answer to the input question, and the presentation unit 205 may present the answer as well. This brings about, in addition to the effect brought about by the information processing apparatus 1 in accordance with the first example embodiment, the effect of enabling a doubt that a person who has input a question (for example, a recommender or a target person) holds to be interactively cleared through the use of the responding unit 204, which is originally a unit for generating an answer to a question generated by the generation unit 203.

Note that the input of a question may be received via the input unit 22. For example, in a case where the input unit 22 is an apparatus that receives input of characters, such as a keyboard, the input of a question may be performed by inputting characters. Alternatively, the input unit 22 may be an apparatus that receives input of voice, such as a speaker. In this case, a configuration may be employed in which the input of a question is performed by inputting voice, and the voice input by the information processing apparatus 2 or an apparatus outside the information processing device 2 is converted into character data. As a matter of course, a configuration may be employed in which the input of a question is received by an apparatus outside the information processing device 2, and the responding unit 204 acquires the input received by that apparatus via the communication unit 24.

### (Flow of Information Presentation Method)

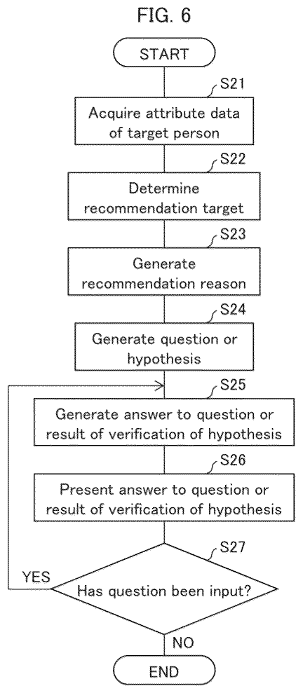

A flow of an information presentation method carried out by the information processing apparatus 2 will be described with reference to FIG. 6. FIG. 6 is a flowchart illustrating a flow of an information presentation method in accordance with the present example embodiment.

In S21, the recommendation unit 201 acquires attribute data of a target person. The attribute data is used for the determination of a recommendation target and indicates an attribute of the target person. Subsequently, in S22, the recommendation unit 201 determines a recommendation target on the basis of the attribute data acquired in S21. As described in the section “Recommendation target determination method and recommendation reason generation method”, the recommendation unit 201 may determine a recommendation target on the basis of an output value of the prediction model 211. Note that the presentation unit 205 may present the recommendation target after the recommendation target has been determined in S22.

In S23, the recommendation reason generation unit 202 generates a recommendation reason for recommendation of the recommendation target determined in S22. A method for generating the recommendation reason is as described in the section “Recommendation target determination method and recommendation reason generation method”. Note that the presentation unit 205 may present the recommendation reason after the recommendation reason has been generated in S23.

In S24, the generation unit 203 generates a question or a hypothesis appropriate to the recommendation target determined in S22. As described in the section “Question and hypothesis generation method”, the generation unit 203 may generate a question and a hypothesis with use of the generation model 212.

In S25, the responding unit 204 generates an answer to the question generated in S24 or a result of verification of the hypothesis generated in S24. A method for generating the answer and the result of verification is as described in the section “Answer generation method and hypothesis verification method”.

In S26, the presentation unit 205 presents the answer generated in S25 or the result of verification generated in S25. At this time, the presentation unit 205 preferably presents, in addition to the answer generated in S25 or the result of verification generated in S25, the question corresponding to the answer or the hypothesis corresponding to the result of verification. Further, in a case where the recommendation target and the recommendation reason are not presented in S22 and in S23, respectively, the presentation unit 205 may present the recommendation target and the recommendation reason in S26.

In S27, the responding unit 204 determines whether or not a question about the answer presented in S26 or about the result of verification presented in S26 has been input. In a case where a determination result in S27 is YES, the process returns to S25, and the responding unit 204 generates an answer to the input question. Subsequently, in S26, the presentation unit 205 presents the answer. On the other hand, in a case where the determination result in S27 is NO, the process in FIG. 6 ends.

As described above, the information presentation method in accordance with the present example embodiment includes: generating a question or a hypothesis appropriate to a recommendation target which has been determined to be a target to be recommended to a target person (S24); and presenting an answer to the generated question or a result of verification of the generated hypothesis (S26). Thus, the present information presentation method brings about the effect of making it possible to present useful information for recommending a recommendation target.

### [Variation]

The processes described in the foregoing example embodiments may be carried out by any entity, which is not limited to the foregoing examples. That is, an information presentation system including the same functions as those of the information processing apparatus 2 can be constructed by a plurality of apparatuses that are capable of communicating with each other. For example, an information presentation system having the same functions as those of the information processing apparatus 2 can be constructed, by dispersedly providing the blocks illustrated in FIG. 4 in a plurality of respective apparatuses. Further, the processes in the flowchart illustrated in FIG. 6 can be carried out by being shared between a plurality of processors.

### [Software Implementation Example]

Some or all of the functions of each of the information processing apparatuses 1 and 2 may be realized by hardware such as an integrated circuit (IC chip) or may be alternatively realized by software.

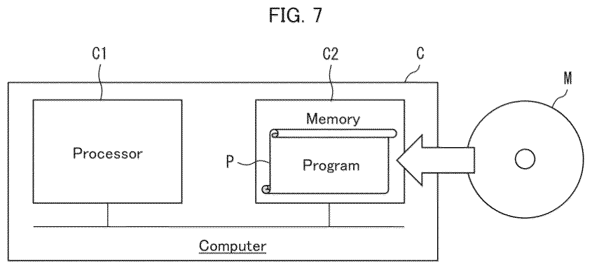

In the latter case, the information processing apparatuses 1 and 2 are each realized by, for example, a computer that executes instructions of a program that is software realizing the functions. FIG. 7 illustrates an example of such a computer (hereinafter referred to as “computer C”). The computer C includes at least one processor C1 and at least one memory C2. The memory C2 stores a program (information presentation program) P for causing the computer C to operate the information processing apparatus 1 or 2. In the computer C, the processor C1 reads the program P from the memory C2 and executes the program P, so that the functions of the information processing apparatus 1 or 2 are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded at the execution of the program P and in which various kinds of data are temporarily stored. The computer C can further include a communication interface for carrying out transmission and reception of data with other apparatuses. The computer C can further include an input-output interface for connecting input-output apparatuses such as a keyboard, a mouse, a The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following example aspects.

### (Supplementary Note 1)

An information processing apparatus including: a generation means for generating a question or a hypothesis appropriate to a recommendation target which has been determined to be a target to be recommended to a target person; and a presentation means for presenting an answer to the question generated by the generation means or a result of verification of the hypothesis generated by the generation means.

### (Supplementary Note 2)

The information processing apparatus described in supplementary note 1, including a recommendation reason generation means for generating a recommendation reason for recommendation of the recommendation target, wherein the generation means generates the question or the hypothesis on a basis of the recommendation reason.

### (Supplementary Note 3)

The information processing apparatus described in supplementary note 1 or 2, including a recommendation means for determining the recommendation target appropriate to an attribute of the target person with use of a prediction model that has been generated by learning a relationship between an attribute of a person and a result of recommendation of a recommendation target to the person who has the attribute or a relationship between an attribute of a person and a recommendation target to be recommended to the person who has the attribute, wherein the generation means generates the question or the hypothesis on a basis of a degree of likelihood of a prediction result obtained by the prediction model.

### (Supplementary Note 4)

The information processing apparatus described in any of supplementary notes 1 to 3, wherein the generation means generates the question or the hypothesis on a basis of an attribute of the target person.

### (Supplementary Note 5)

The information processing apparatus described in any of supplementary notes 1 to 4, wherein the generation means generates the question or the hypothesis on a basis of an attribute of a recommender who recommends the recommendation target to the target person.

### (Supplementary Note 6)

The information processing apparatus described in any of supplementary notes 1 to 5, wherein the generation means generates the question or the hypothesis with use of a generation model that has been generated by learning a relationship between a recommendation target and a question or a hypothesis appropriate to the recommendation target.

### (Supplementary Note 7)

The information processing apparatus described in any of supplementary notes 1 to 6, including a responding means for generating an answer to the question generated by the generation means or a result of verification of the hypothesis generated by the generation means, wherein in a case where a question about the answer presented by the presentation means or about the result of verification presented by the presentation means has been input, the responding means generates an answer to the input question, and the presentation means presents the answer, generated by the responding means, to the input question.

### (Supplementary Note 8)

An information presentation method including: at least one processor generating a question or a hypothesis appropriate to a recommendation target which has been determined to be a target to be recommended to a target person; and the at least one processor presenting an answer to the generated question or a result of verification of the generated hypothesis.

### (Supplementary Note 9)

An information presentation program for causing a computer to function as: a generation means for generating a question or a hypothesis appropriate to a recommendation target which has been determined to be a target to be recommended to a target person; and a presentation means for presenting an answer to the question generated by the generation means or a result of verification of the hypothesis generated by the generation means.

### [Additional Remark 3]

Furthermore, some of or all of the foregoing example embodiments can also be described as below. An information processing apparatus including at least one processor, the at least one processor carrying out: a process for generating a question or a hypothesis appropriate to a recommendation target which has been determined to be a target to be recommended to a target person; and a process for presenting an answer to the generated question or a result of verification of the generated hypothesis.

Note that the information processing apparatus can further include a memory. The memory can store an information presentation program for causing the processor to carry out the process for generating a question or a hypothesis and the process for presenting an answer or a result of verification. The program can be stored in a computer-readable non-transitory tangible storage medium.

### REFERENCE SIGNS LIST

1, 2: information processing apparatus
201: recommendation unit (recommendation means)
202: recommendation reason generation unit (recommendation reason generation means)
11, 203: generation unit (generation means)
204: responding unit (responding means)
12, 205: presentation unit (presentation means)
211: prediction model
212: generation model

What is claimed is:

1. An information processing apparatus comprising at least one processor, the at least one processor carrying out:
a generation process for generating a question or a hypothesis appropriate to a recommendation target which has been determined to be a target to be recommended to a target person; and
a presentation process for presenting an answer to the question generated in the generation process or a result of verification of the hypothesis generated in the generation process.

2. The information processing apparatus according to claim 1, wherein
the at least one processor further carries out a recommendation reason generation process for generating a recommendation reason for recommendation of the recommendation target, and
in the generation process, the at least one processor generates the question or the hypothesis on a basis of the recommendation reason.

3. The information processing apparatus according to claim 1, wherein
the at least one processor further carries out a recommendation process for determining the recommendation target appropriate to an attribute of the target person with use of a prediction model that has been generated by learning a relationship between an attribute of a person and a result of recommendation of a recommendation target to the person who has the attribute or a relationship between an attribute of a person and a recommendation target to be recommended to the person who has the attribute, and
in the generation process, the at least one processor generates the question or the hypothesis appropriate to a degree of likelihood of a prediction result obtained by the prediction model.

4. The information processing apparatus according to claim 1, wherein
in the generation process, the at least one processor generates the question or the hypothesis on a basis of an attribute of the target person.

5. The information processing apparatus according to claim 1, wherein
in the generation process, the at least one processor generates the question or the hypothesis on a basis of an attribute of a recommender who recommends the recommendation target to the target person.

6. The information processing apparatus according to claim 1, wherein
in the generation process, the at least one processor generates the question or the hypothesis with use of a generation model that has been generated by learning a relationship between a recommendation target and a question or a hypothesis appropriate to the recommendation target.

7. The information processing apparatus according to claim 1, wherein
the at least one processor further carries out a responding process for generating an answer to the question generated in the generation process or a result of verification of the hypothesis generated in the generation process,
in the responding process, in a case where a question about the answer presented in the presentation process or about the result of verification presented by in the presentation process has been input, the at least one processor generates an answer to the input question, and
the at least one processor presents the answer, generated in the responding process, to the input question.

8. An information presentation method comprising:
at least one processor generating a question or a hypothesis appropriate to a recommendation target which has been determined to be a target to be recommended to a target person; and
the at least one processor presenting an answer to the generated question or a result of verification of the generated hypothesis.

9. A computer-readable, non-transitory storage medium storing a program for causing a computer to carry out:
a generation process for generating a question or a hypothesis appropriate to a recommendation target which has been determined to be a target to be recommended to a target person; and
a presentation process for presenting an answer to the question generated in the generation process or a result of verification of the hypothesis generated in the generation process.
